(19) United States
(12) Patent Application Publication
(10) Pub. No.: US 2004/0104094 A1
(43) Pub. Date: Jun. 3, 2004

(54) Auxiliary transmission

(76) Inventors: Christoph Pelchen, Tettnang (DE); Unal Gazyakan, Friedrichshafen (DE); Barbara Schmohl, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/696,758

(22) Filed: Oct. 29, 2003

(30) Foreign Application Priority Data
Nov. 28, 2002 (DE) 102 55 392.0

(51) Int. Cl. B60K 23/08

(52) U.S. Cl. 192/84.6

(57) ABSTRACT

An auxiliary transmission (31) with a controllable clutch (2) for the optional distribution of a drive output torque to one or more drive output shafts (5, 6) and with an electric motor (8) for controlling the clutch (2) is described. The electric motor (8) is arranged in a coupling zone (18) of the auxiliary transmission (31) to a main transmission unit (17).

The invention concerns an auxiliary transmission of the type defined in more detail in the preamble of claim 1.

From current practice auxiliary transmissions or longitudinal auxiliary transmissions are known for a vehicle in which all-wheel drive can be engaged, which are made with a controllable clutch for engaging the all-wheel drive and with a planetary gear wheel assembly as the transmission ratio step for an off-road gear that can be engaged while driving. When the all-wheel drive is engaged, a second drive output shaft is connected via the controllable clutch which is made as a disk clutch, to a transmission input shaft. The controllable clutch is actuated or controlled by an electric motor respectively to engage or disengage the all-wheel drive.

In addition, it is provided that actuation of the off-road gear engagement of a longitudinal auxiliary transmission also takes place by means of an electric motor. In the auxiliary transmissions known from current practice, the electric motor, by means of which the clutch or all-wheel drive and also the off-road gear are actuated, is arranged in the area of a first drive output shaft or in the area of a second drive output shaft which is connected with the transmission input shaft via a chain.

However, these two alternative arrangements of the electric motor or control motor for actuating an off-road gear of an auxiliary transmission have the disadvantage that a center of gravity of the auxiliary transmission is displaced away from a coupling zone of the auxiliary transmission to a main transmission unit in the direction of the drive output of the auxiliary transmission. Owing to this, during the operation of the auxiliary transmission more pronounced vibrations are produced because of the larger vibration amplitudes in the area of the drive output, that result in undesirably high component loading of the electric motor which shortens its life disadvantageously.

In addition, in vehicles there is little structural space available on the drive output side of the auxiliary transmission and, for that reason, the electric motor is sometimes arranged close to a catalyser of the motor vehicle. Under unfavorable operating conditions the catalyser adjacent to the electric motor can affect the operation of the electric motor adversely owing to the high operating temperatures of the catalyser.

Accordingly, the purpose of the present invention is to provide an auxiliary transmission which, by virtue of its design, makes optimum use of the existing structural space in a vehicle and in which the reliable operation of an electric motor is ensured.

According to the invention this objective is achieved with an auxiliary transmission having the characteristics of claim 1.

With the auxiliary transmission, the electric motor for controlling the controllable clutch is arranged in a coupling zone of the auxiliary transmission to a main transmission unit, the vibrational loading on the electric motor or control motor is considerably reduced so that the life of the electric motor is advantageously extended.

According to the invention, this reduced vibrational loading results from the fact that thanks to the arrangement of the electric motor in the area of the coupling of the auxiliary transmission to the main transmission unit of a range-change transmission system, a center of gravity of the auxiliary transmission housing is positioned closer to the connection between the auxiliary transmission and the main transmission unit, so that in a simple way the vibrations acting on the electric motor are reduced.

Furthermore, according to the invention, the arrangement with the electric motor of the auxiliary transmission, next to the drive input shaft of the auxiliary transmission, leads to the advantage that on the drive output side of the auxiliary transmission less structural space is needed, and adverse effects on the functioning of the electric motor or control motor of the controllable clutch of the auxiliary transmission due to the high operating temperatures of a catalyser as in the solutions known from current practice, are avoided.

It is also advantageous that, thanks to the arrangement of the electric motor according to the invention, a housing of the auxiliary transmission can be designed optimally in relation to the total weight of the auxiliary transmission.

Further advantages and advantageous design features of an auxiliary transmission according to the invention emerge from the description, the drawing and the claims. The drawing shows:

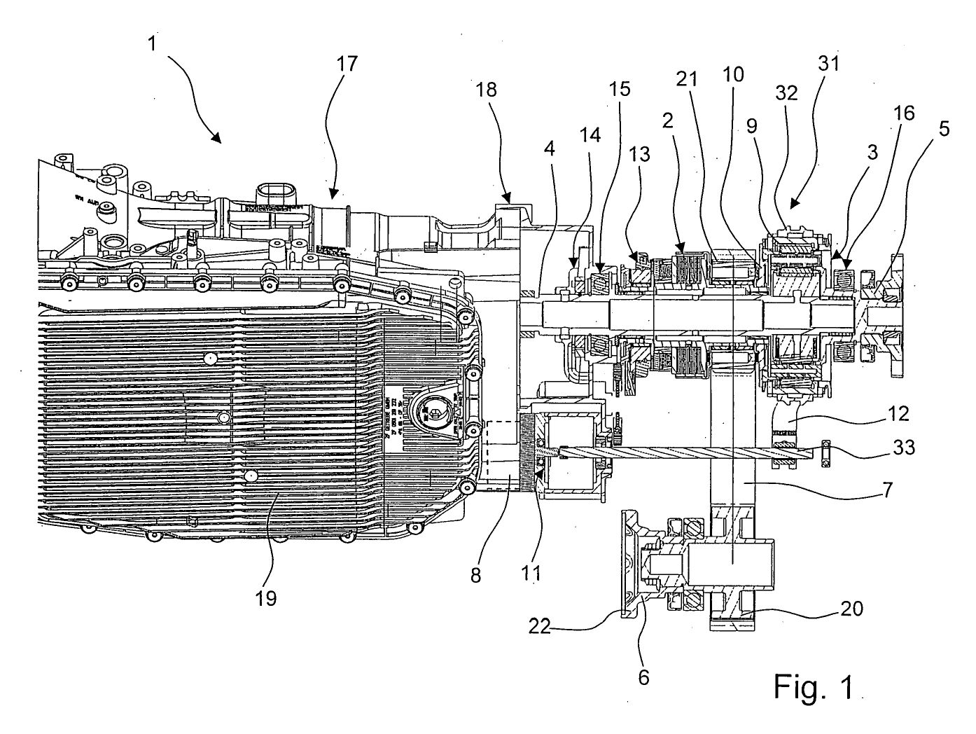

FIG. 1 is a first example embodiment of a range-change transmission consisting of a main transmission unit and an auxiliary transmission according to the invention; and

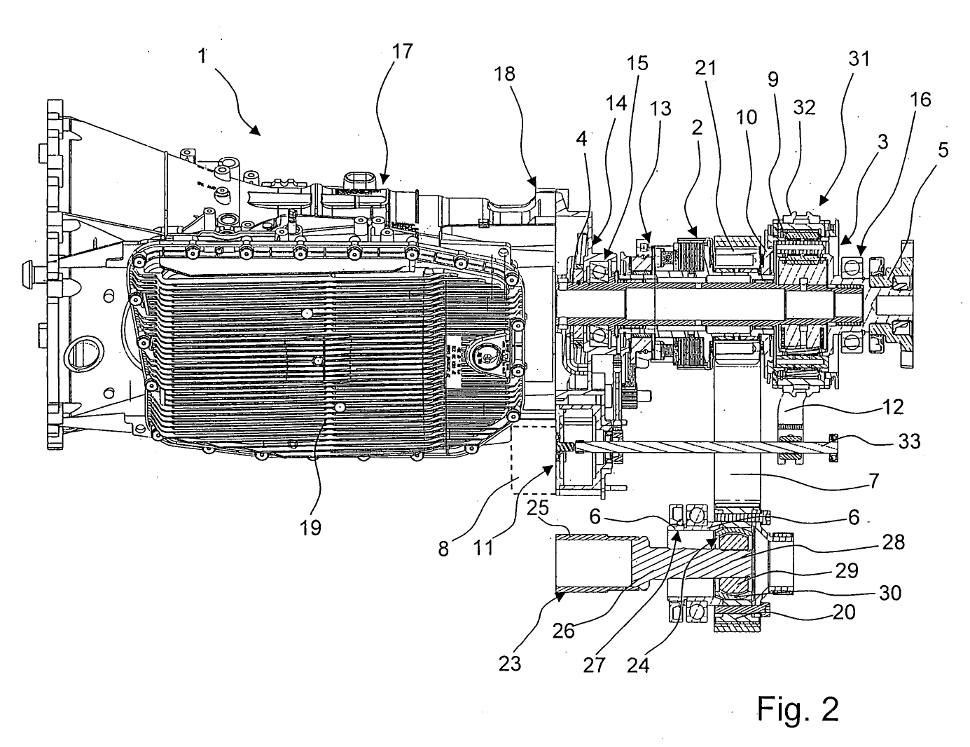

FIG. 2 is a second example embodiment of a range-change transmission with a main transmission unit and an auxiliary transmission according to the invention.

With reference to FIG. 1, a range-change transmission 1 is shown, which comprises a main transmission unit 17 and a longitudinal auxiliary transmission or auxiliary transmission 31 with a controllable clutch 2, for a vehicle not shown in any detail. The auxiliary transmission 31 is made with a planetary gear wheel assembly 3 as the transmission stage or reduction stage for an off-road gear that can be engaged while driving.

A drive torque delivered by a drive motor (not shown) is led into the auxiliary transmission 31 via a drive input shaft 4 and transferred via a first drive output shaft 5 and a second drive output shaft 6 to two drive shafts (not shown) of the vehicle, the second drive output shaft 6 being driven by the drive input shaft 4 via a chain 7. The connection between the drive input shaft 4 and the second drive output shaft 6 can be controlled by virtue of the clutch 2 formed as a disk clutch in such manner that the connection is formed when the clutch 2 is engaged or closed, and interrupted when the clutch 2 is open. The all-wheel drive is therefore engaged or disengaged by means of the clutch 12 which, in combination with the chain 7, constitutes a so-termed distributor unit for the optional distribution of a drive output torque to the first drive output shaft 5 or to both drive output shafts 5, 6 of the auxiliary transmission 31.

Actuation of the clutch 2, i.e., engagement and disengagement of the clutch takes place via an electric motor 8. The actuation of the clutch 2 depends on the respective rotational direction of the electric motor 8, in the sense of whether the clutch 2 is opened or closed. Moreover, the planetary gear wheel assembly 3 is also actuated by the electric motor 8. For this, the electric motor 8 is in active connection with the planetary gear wheel assembly 3 via a shaft 33, a rocker arm 12 and a sliding bush 32.

The shaft 33 is displaced by a spherical-thread drive in the axial direction of the auxiliary transmission 31, whereby the sliding bush 32 can be moved between two engagement positions. In a first engagement position of the sliding bush 32, an annular gear wheel 9 of the planetary gear wheel assembly 3 is connected to a web 10 of the planetary gear wheel assembly. In the second engagement position of the sliding bush 32, the annular gear wheel 9 is connected fast to a transmission housing of the auxiliary transmission 1 not shown in detail. The off-road gear of the auxiliary transmission 31 is engaged when the annular gear wheel 9 is connected fast to the transmission housing of the auxiliary transmission 31 by virtue of claw teeth of the sliding bush 32. When the annular gear wheel 9 is connected rotationally fast to the web or planetary gear support 10 of the planetary gear wheel assembly 3 by the claw teeth of the sliding bush 32, the off-road gear of the auxiliary transmission 1 is deactivated.

Actuation of the controllable clutch 2 takes place via a transfer device 13 provided between the electric motor 8 and the clutch 2, whose mode of action corresponds approximately to that of the spherical-thread drive 11 in combination with the rocker arm 12, namely to transform a rotary movement of the electric motor 8 into a translational actuation movement so that the clutch 2 can be actuated by the electric motor.

At the end of the auxiliary transmission 1 facing away from the planetary gear wheel assembly 3 a hydraulic pump 14 is arranged directly on the drive input shaft 4, which is provided in order to supply the auxiliary transmission 1 with oil and which is driven at the speed of the drive input shaft 4. The arrangement of this hydraulic pump 14 ensures that even when the off-road gear is engaged the delivery performance of the hydraulic pump 14 remains constant, since the drive input speed to the hydraulic pump 14 remains constant notwithstanding the change in transmission ratio when the off-road gear is engaged.

Furthermore, the hydraulic pump 14 is arranged on the drive input shaft 4 side before a first transmission bearing 15, so that the distance between the said first transmission bearing 15 and a second transmission bearing 16 is smaller than if the pump were arranged between the two transmission bearings 15, 16. This minimizes the bend loading of the drive input shaft 4 and that of the first drive output shaft 5, so that in relation to bend loading the shafts 4 and 5 can be made smaller. In this way a weight reduction is simply achieved, as well as a reduction of the production cost of the auxiliary transmission 31.

The arrangement of the planetary gear wheel assembly 3 on the first drive output shaft 5 on the output side, i.e., at the end of the auxiliary transmission 31 facing away from the coupling zone 18, offers the possibility that the present auxiliary transmission according to the invention can also be made without the planetary gear wheel assembly 3 or reduction gear stage with little constructional effort. Thus, the auxiliary transmission according to the invention has a modular structure which can be simply and inexpensively adapted to various application cases. Accordingly, depending on the application in question additional functions required in the auxiliary transmission can be integrated in the auxiliary transmission with little effort, or if necessary functions not needed can be omitted with very little effort.

FIG. 2 shows the range-change transmission 1 illustrated in FIG. 1 with the auxiliary transmission 31 and the main transmission unit 17 connected therewith, the difference between the range-change transmissions according to FIGS. 1 and 2 existing only in the area of the second drive output shaft 6. For that reason and for the sake of clarity, components with the same structure and function are indexed in the same way in the description.

From the representations of FIGS. 1 and 2 it can be seen that the electric motor 8 is arranged in the coupling zone 18 between the auxiliary transmission 31 and the main transmission unit 17, so that a centre of gravity of the auxiliary transmission 31 is displaced in the direction of the coupling zone 18. The displacement of the center of gravity of the auxiliary transmission 31 has the result that the electric motor 8 or adjustment motor for the clutch 2 and the sliding bush 32 are considerably less affected by vibration loading, which as expected extends the life of the electric motor 8 and which also makes it unnecessary to have any additional fastening of the electric motor 8 to the transmission housing 19 of the main transmission unit 17.

The electric motor 8 is arranged in the coupling zone 18 between the auxiliary transmission 1 and the main transmission unit 17 in such manner that it projects beyond an area of the main transmission unit 17 facing towards the auxiliary transmission 1 and is positioned outside a housing 19 of the main transmission unit. This allows the housing 19 of the main transmission unit 17 to be designed independently of the electric motor 8 and simplifies the assembly of the range-change transmission 1 as a whole.

Obviously, as an alternative to this it is a matter for the judgement of a person with knowledge of the field to attach the electric motor by appropriate means either to the housing of the auxiliary transmission or to that of the main transmission unit or to both at the same time. In addition it can also be provided that a damper element is arranged between the electric motor and the housing of the auxiliary transmission and between the electric motor and the housing of the main transmission unit respectively, to ensure or achieve vibration decoupling between the auxiliary transmission, the main transmission unit and the electric motor and to avoid juddering impact between these structural groups during operation.

The second drive output shaft 6 has a first gear wheel 20 or drive output gear over which is led the chain 7 that connects the drive input shaft 4 and the second drive output shaft. In the area of the drive input shaft 4 the auxiliary transmission 31 has a second gearwheel 21, which can be connected rotationally fast with the drive input shaft 4 by means of the clutch 2 and over which the chain 7 is also led. This means that when the clutch 2 is closed, a torque transferred by the drive input shaft 4 into the auxiliary transmission 31 is transmitted to the second drive output shaft 6 via the clutch 2, the second gear wheel 21, the chain 7 and the first gear wheel or drive output gear 20 connected rotationally fast to the second drive output shaft 6.

In the embodiment shown in FIG. 1 the second drive output shaft 6 is formed with a drive output flange 22 to which a cardan shaft known as such and not shown here can be attached with several bolt connections. The cardan shaft serves to connect the auxiliary transmission 31 to one of the drive shafts of the vehicle, which in turn is connected to the drive wheels of the vehicle.

The cardan shaft consists of two universal joints and a tubular component arranged between the two universal joints. The universal joints are provided in order to compensate any offset between the rotation axis of the second drive output shaft 6 of the auxiliary transmission 31 and the rotation axis of the drive shaft connected to the drive wheels of the vehicle. By virtue of this design of the connection between the second drive output shaft 6 of the auxiliary transmission and a drive shaft of the vehicle, any variable offsets between the second drive output shaft 6 and the drive shaft of the drive wheels that occur during the vehicle's driving operation can be compensated. Furthermore, the use of the cardan shaft enables uniform transfer of a torque from the auxiliary transmission 31 to the drive wheels in active connection with the second drive output shaft 6.

The design of the second drive output shaft 6 with the drive output flange 22 shown in FIG. 1 is a structure known as such from current practice, in which a very large distance has to be provided between the auxiliary transmission 31 and the main transmission unit 17 in order to keep a deflection angle arising due to the offset between the second drive output shaft 6 and the drive shaft of the drive wheels of a vehicle below a certain upper limit. In this case the said upper limit is that value of the deflection angle of the cardan shaft above which the torque can no longer be transmitted via the cardan shaft.

To be able to reduce the distance between the auxiliary transmission 1 and the main transmission unit 17 in the coupling zone 18, in the embodiment of the auxiliary transmission 31 shown in FIG. 2 the universal joint 24 arranged on the end of the cardan shaft 23 facing towards the second drive output shaft 6 is integrated in the first gear wheel 20. This increases the distance between the two link points of the two universal joints of the cardan shaft 23, so that the deflection angle of the cardan shaft is reduced. This measure allows larger offsets to be accommodated between the auxiliary transmission 31 or its second drive output shaft 6 and the drive shaft of the drive wheels, than with the embodiment of the auxiliary transmission 31 shown in FIG. 1.

Conversely, integration of the universal joint 24 in the second gear wheel 21 of the auxiliary transmission 31 makes it possible to reduce the distance between the auxiliary transmission 31 and the main transmission unit 17 in the coupling zone 18 without increasing the deflection angle of the cardan shaft compared with the version of the auxiliary transmission 31 shown in FIG. 1. Advantageously, this reduction of the distance between the auxiliary transmission 31 and the main transmission unit 17 results in a displacement of the center of gravity of the drive train towards the main transmission unit 17, whereby the rigidity and the characteristic bending frequency of the vehicle's drive train are increased as a whole.

Moreover, integration of the universal joint 24 in the second gear wheel 21 of the auxiliary transmission 31 leads to a reduction of the overall weight of the auxiliary transmission 31 and the cardan shaft 23, when the range-change transmission is made more compact. This is the case when the larger distance between the universal joints of a cardan shaft is used to reduce the distance between the auxiliary transmission 31 and the main transmission unit 17, because less material is then used.

The cardan shaft 23 in FIG. 2 consists in this case of a hollow cylindrical section 25 and a cylindrical pin 26 whose diameter is smaller than that of the said hollow cylindrical section 25, which is welded to a bearing shaft 28 of the universal joint 24 in an area 27.

The bearing shaft 28 is connected rotationally fast to a bearing element 29 shaped spherically on its outside, which is in turn arranged and able to tilt freely in a bearing shell 30. Between the bearing element 29 and the bearing shell 30 is provided a rotationally fast connection known as such and not shown here. By virtue of this rotationally fast connection the torque transferred by the chain 7 is transmitted from the first gear wheel 20 to the universal joint 24 and so to the cardan shaft 23.

### Reference numerals

1 Range-change transmission

2 Clutch

3 Planetary gear wheel assembly

4 Drive input shaft

5 First drive output shaft

6 Second drive output shaft

7 Chain

8 Electric motor

9 Annular gear wheel

10 Web

11 Spherical thread drive

12 Rocker arm

13 Transfer device

14 Hydraulic pump

15 First transmission bearing

16 Second transmission bearing

17 Main transmission unit

18 Coupling zone

19 Housing of the main transmission unit

20 First gear wheel

21 Second gear wheel

22 Drive output flange

23 Cardan shaft

24 Universal joint

25 Hollow cylindrical section

26 Cylindrical pin

27 Area

28 Bearing shaft

29 Bearing element

30 Bearing shell

31 Longitudinal auxiliary transmission, auxiliary transmission

32 Sliding bush

32 Shaft

1. Auxiliary transmission (31) with a controllable clutch (2) for the optional distribution of a drive output torque to one or more drive output shafts (5, 6) and with an electric motor (8) for controlling the clutch (2), characterized in that the electric motor (8) is arranged in a coupling zone (18) of the auxiliary transmission (31) to a main transmission unit (17).

2. Auxiliary transmission according to claim 1, characterized in that the electric motor (8) is arranged in such manner that it projects beyond an area of the main transmission unit (17) which faces the auxiliary transmission (1).

3. Auxiliary transmission according to claims 1 or 2, characterized in that the electric motor (8) is arranged outside a housing (19) of the main transmission unit (17) and is connected to a housing of the auxiliary transmission (1) and/or to the housing (19) of the main transmission unit (17).

4. Auxiliary transmission according to any of claims 1 to 3, characterized in that a damper element is arranged between the electric motor (8) and the housing (19) of the main transmission unit (17).

5. Auxiliary transmission according to any of claims 1 to 4, characterized in that a hydraulic pump (14) is arranged outside a mounting (15, 16) of the auxiliary transmission (1).

6. Auxiliary transmission according to any of claims 1 to 5, characterized in that a reduction gear stage (3) is provided, which is connected in series after the clutch (2).

7. Auxiliary transmission according to claim 6, characterized in that the reduction gear stage (3) can be controlled by the electric motor (8).
